(19) United States
(12) Patent Application Publication
(10) Pub. No.: US 2025/0059465 A1
(43) Pub. Date: Feb. 20, 2025

(54) CLEANING AGENT COMPOSITION FOR HARD ARTICLES

(71) Applicant: KAO CORPORATION, Tokyo (JP)

(72) Inventor: Dongyao LI, Wakayama-shi (JP)

(73) Assignee: KAO CORPORATION, Tokyo (JP)

(21) Appl. No.: 18/721,351

(22) PCT Filed: Dec. 9, 2022
(86) PCT No.: PCT/JP2022/045430

§ 371 Date: Jun. 18, 2024

(30) Foreign Application Priority Data
Dec. 20, 2021 (JP) 2021-205712

(51) Int. Cl. C11D 1/86; B08B 3/00; C11D 1/22; C11D 1/62; C11D 1/66; C11D 1/72; C11D 1/75; C11D 3/43; C11D 17/00

(52) U.S. Cl. CPC C11D 1/86; B08B 3/003; C11D 3/43; C11D 17/003; C11D 1/22; C11D 1/62; C11D 1/662; C11D 1/72; C11D 1/75

(57) ABSTRACT

Provided are a cleaning agent composition for hard articles, a method for cleaning a hard article and a method for increasing foamability of a cleaning agent composition for hard articles, excellent in cleaning durability when cleaning hard articles with foam made by foaming the composition.

A cleaning agent composition for hard articles containing, (a) a nonionic surfactant containing a polyoxyalkylene alkyl or alkenyl amine in which the alkyl group or alkenyl group has 8 or more and 18 or less carbons and the oxyalkylene group has an average number of added moles of 1 or more and 8 or less, (b) a quaternary ammonium salt-type surfactant, and water, wherein a content of (c) an anionic surfactant and an amphoteric surfactant is 0 mass % or more and 20 mass % or less in a total surfactant content.

### FIELD OF THE INVENTION

The present invention relates to a cleaning agent composition for hard articles, a method for cleaning a hard article and a method for increasing foamability of a cleaning agent composition for hard articles.

### BACKGROUND OF THE INVENTION

Generally, as kitchen cleaning agents used for kitchen items such as microwave ovens, ovens, walls or floors around microwave ovens, and extractor fans, or as cleaning agents used for food processing facilities, cleaning agents containing surfactants, solvents and alkali agents or the like are used for removing oil stains denatured by the action of heat, sunlight, oxygen in the air and others. However, there are problems with cleaning agents containing alkali agents, such as strong irritation to the skin or the like, and others, and they need to be handled with care. Further, workers not used to handling strong alkalis, such as part-time workers or the like, are increasing. Thus, there is a strong need for technology that allows denatured oil stains which are generally stubborn and difficult to remove to be cleaned by easy-to-handle neutral cleaning agents.
JP-A 2020-97711 discloses a neutral cleaning agent composition containing a mono or polyoxyethylene alkyl or alkenyl amine and a specific solvent.
JP-A 2001-247892 discloses a technology of a cleaning agent for floors containing a cationic surfactant and a mono or polyoxyethylene alkyl or alkenyl amine.
JP-A 2015-101674 discloses a technology of a laundry detergent containing a cationic surfactant and a mono or polyoxyethylene alkyl or alkenyl amine.

### SUMMARY OF THE INVENTION

The cleaning agent composition of JP-A 2020-97711 has excellent detergency for denatured oil stains. When such cleaning agent compositions are used for hard articles, they are generally foamed and brought into contact with hard articles as foam from the viewpoint of cleaning power, convenience, permeability into stains or the like. Further, in a cleaning method frequently employed in many cases, such a cleaning agent composition is applied to a flexible material such as a sponge or the like and foamed, the foam is brought into contact with hard articles, and the hard articles are scrubbed and cleaned, or the like, and it is desirable that the cleaning agent composition be excellent in cleaning durability which enables many hard articles to be cleaned with the foam made per application thereof to the flexible material. The cleaning agent composition of JP-A 2020-97711 also has good foamability, but further improvement is desired.

Further, the cleaning agent compositions described in JP-A 2001-247892 and JP-A 2015-101674 neither need foaming power nor suggest that the cationic surfactants act as foaming increasing agents.

The present invention provides a cleaning agent composition for hard articles, a method for cleaning a hard article and a method for increasing foamability of a cleaning agent composition for hard articles, excellent in cleaning durability when cleaning hard articles with foam made by foaming the composition.

The present invention relates to a cleaning agent composition for hard articles containing, (a) a nonionic surfactant [hereinafter referred to as component (a)] containing a polyoxyalkylene alkyl or alkenyl amine [hereinafter referred to as component (a1)] in which the alkyl group or alkenyl group has 8 or more and 18 or less carbons and the oxyalkylene group has an average number of added moles of 1 or more and 8 or less, (b) a quaternary ammonium salt-type surfactant [hereinafter referred to as component (b)] and water, wherein a content of (c) an anionic surfactant and an amphoteric surfactant [hereinafter referred to as component (c)] is 0 mass % or more and 20 mass % or less in a total surfactant content.

Further, the present invention relates to a method for cleaning a hard article including, foaming the cleaning agent composition for hard articles of the present invention and bringing the same into contact with the hard article adhered with a stain.

Further, the present invention relates to a method for increasing foamability of a cleaning agent composition for hard articles, the cleaning agent composition for hard articles containing component (a) and water, the method including containing component (b) in the composition.

According to the present invention, provided are a cleaning agent composition for hard articles, a method for cleaning a hard article and a method for increasing foamability of a cleaning agent composition for hard articles, excellent in cleaning durability when cleaning hard articles with foam made by foaming the composition.

### EMBODIMENTS OF THE INVENTION

While a mechanism of action whereby the effect of the present invention is expressed is not necessarily fully elucidated, the applicant believes the following.

The specific polyoxyalkylene alkyl or alkenyl amine of component (a1) of the present invention is a surfactant having very excellent cleaning power for denatured oil stains, but has poor foamability. Generally, anionic surfactants having high foam increasing properties, like component (c), are contained in cleaning agent compositions to enhance foamability, but in the presence of anionic surfactants, component (a1) of the present invention tends to have impaired cleaning power, as well as causing a non-foaming phenomenon. This is considered to be because component (a1) is cationic and thus forms a composite with component (c).

On the other hand, a quaternary ammonium salt-type surfactant, component (b) of the present invention, is generally not considered to act as a foam increasing agent. However, the cleaning agent composition for hard articles of the present invention can enhance foamability of the cleaning agent composition by using components (a1) and (b) in combination and without formation of a composite of components (a1) and (c) even if component (c) is contained. This is surprising.

Note that the mechanism of action whereby the effect of the present invention is expressed is not limited to the above.

### <Cleaning Agent Composition for Hard Articles>

<Component (a)>

The cleaning agent composition for hard articles of the present invention contains as component (a), a nonionic surfactant containing (a1) a polyoxyalkylene alkyl or alkenyl amine in which the alkyl group or alkenyl group has 8 or more and 18 or less carbons and the oxyalkylene group has an average number of added moles of 1 or more and 8 or less.

Component (a1) is a polyoxyalkylene alkyl or alkenyl amine in which the alkyl group or alkenyl group has 8 or more and 18 or less carbons and the oxyalkylene group has an average number of added moles of 1 or more and 8 or less.

Component (a1) has an alkyl group or an alkenyl group with 8 or more and preferably 10 or more, and 18 or less, preferably 16 or less and more preferably 14 or less carbons from the viewpoint of foam durability during cleaning.

Component (a1) preferably has an alkyl group, more preferably has a linear alkyl group and further preferably has a linear primary alkyl group.

The oxyalkylene group is preferably an oxyalkylene group with 2 carbons and/or an oxyalkylene group with 3 carbons, in other words, an oxyethylene group and/or an oxypropylene group, and more preferably an oxyethylene group. Component (a1) preferably includes an oxyethylene group as the oxyalkylene group.

The oxyalkylene group of component (a1) has an average number of added moles of 1 or more and preferably 2 or more, and 8 or less, preferably 7 or less and more preferably 5 or less from the viewpoints of foam durability during cleaning and appearance transparency.

Examples of component (a1) include, for example, an alkylene oxide adduct of a monoamine in which an alkyl group or an alkenyl group has 8 or more and 18 or less carbons and the oxyalkylene group has an average number of added moles of 1 or more and 8 or less.

Examples of component (a1) include, for example, a compound represented by the following general formula (a1),

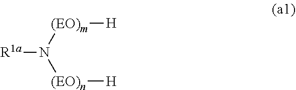

wherein R^{1a} is an alkyl group or an alkenyl group with 8 or more and 18 or less carbons, EO is an ethyleneoxy group, m and n are average numbers of added moles and independently represent numbers of 0 or more and 8 or less, and a total of m and n is 1 or more and 8 or less.

In the formula (a1), R^{1a} has 8 or more and preferably 10 or more, and 18 or less, preferably 16 or less and more preferably 14 or less carbons from the viewpoint of foam durability during cleaning. R^{1a} is preferably an alkyl group. The total of m and n is 1 or more and preferably 2 or more, and 8 or less, preferably 7 or less and more preferably 5 or less from the viewpoints of foam durability during cleaning and appearance transparency.

The cleaning agent composition for hard articles of the present invention preferably contains one or more selected from (a2) an amine oxide-type surfactant (hereinafter referred to as component (a2)), (a3) an alkyl glycoside-type surfactant (hereinafter referred to as component (a3)) and (a4) an alkyl glyceryl ether-type surfactant (hereinafter referred to as component (a4)) and more preferably contains components (a2), (a3) and (a4) as component (a) other than component (a1) from the viewpoints of foam durability during cleaning and foamability.

A compound of the following general formula (a2) is suitable as the amine oxide-type surfactant of component (a2),

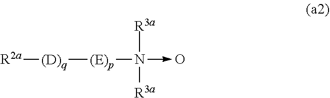

wherein R^{2a} represents a hydrocarbon group, preferably an alkyl group or an alkenyl group and more preferably an alkyl group with 7 or more and 18 or less carbons, R^{3a} and R^{4a} are the same or different and represent alkyl groups with 1 or more and 3 or less carbons, D represents —NHC(═O)— group or —C—(═O)NH— group, E represents an alkylene group with 1 or more and 5 or less carbons, and q and p represent q=0 and p=0 or q=1 and p=1.

In the general formula (a2), when q=1 and p=1, R^{2a} is a hydrocarbon group, preferably an alkyl group or an alkenyl group and more preferably an alkyl group preferably with 7 or more and preferably 9 or more, and 17 or less and preferably 15 or less carbons from the viewpoints of foam durability during cleaning and foamability. Further, when q=0 and p=0, R^{2a} is a hydrocarbon group, preferably an alkyl group or an alkenyl group and more preferably an alkyl group preferably with 8 or more and preferably 10 or more, and 18 or less and preferably 16 or less carbons from the viewpoints of foam durability during cleaning, aesthetic appearance and foamability. In the present invention, q=0 and p=0 is preferable. R^{3a} and R^{4a} are preferably methyl groups with one carbon from the viewpoints of foam durability during cleaning, aesthetic appearance and foamability.

Preferable specific examples of component (a2) include
(1) alkyl (with 8 or more and 18 or less carbons) dialkyl (with 1 or more and 3 or less carbons) amine oxides: capryl dimethylamine oxide, capric dimethylamine oxide, lauryldimethylamine oxide, myristyl dimethylamine oxide, palmityl dimethylamine oxide, stearyl dimethylamine oxide and others, and
(2) amide group containing-type amine oxides (compounds of the general formula (a2) in which q=1 and p=1): caprylic acid amidopropyl dimethylamine oxide, capric acid amidopropyl dimethylamine oxide, lauric acid amidopropyl dimethylamine oxide, myristic acid amidopropyl dimethylamine oxide and others, and one or two or more of these can be used.

A compound represented by the following general formula (a3) is preferable as the alkyl glycoside-type surfactant of component (a3),

R^{5a}—(OR^{6a})ₓG_{y} (a3)
wherein R^{5a} is a hydrocarbon group, preferably an alkyl group or an alkenyl group and more preferably an alkyl group with 8 or more and preferably 10 or more, and 18 or less and preferably 16 or less carbons, R^{6a} is an alkylene group with 2 or more and 4 or less carbons, preferably an ethylene group or a propylene group and more preferably an ethylene group, G is a residue derived from a reducing sugar, x is an average number of added moles of OR^{6a} and represents a number of 0 or more and 6 or less, and y is an average degree of condensation of G and represents a number of 1 or more, and 10 or less, preferably 5 or less and more preferably 2 or less.

In the compound of the general formula (a3), G is a residue derived from a reducing sugar, and the reducing sugar of a raw material of G may be either an aldose or a ketose. Further, examples of the reducing sugar of a raw material of G can include a triose with 3 carbons, a tetrose with 4 carbons, a pentose with 5 carbons or a hexose with 6 carbons. Specific examples of the aldose can include apiose, arabinose, galactose, glucose, lyxose, mannose, gulose, an aldose, idose, talose or xylose. Further, specific examples of the ketose can include fructose. Among these, the reducing sugar of a raw material of G of the present invention is an aldopentose, an aldose with 5 carbons, or an aldohexose, an aldose with 6 carbons and more preferably glucose from the viewpoints of foam durability during cleaning and foamability.

As the alkyl glyceryl ether-type surfactant of component (a4), an alkyl glyceryl ether-type surfactant having one hydrocarbon group, preferably alkyl group or alkenyl group, more preferably alkyl group and further preferably branched alkyl group with 6 or more and preferably 8 or more, and 12 or less and preferably 10 or less carbons is suitable from the viewpoints of foam durability during cleaning and aesthetic appearance.

<Component (b)>

The cleaning agent composition for hard articles of the present invention contains a quaternary ammonium salt-type surfactant as component (b).

The quaternary ammonium salt-type surfactant of component (b) is preferably one or more selected from a compound represented by the following general formula (b1) and a compound represented by the following general formula (b2),

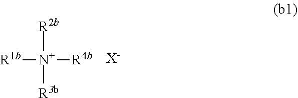

wherein R^{1b} is an aliphatic hydrocarbon group with 8 or more and 18 or less carbons, R^{2b} is a group selected from an aliphatic hydrocarbon group with 8 or more and 18 or less carbons, an alkyl group with 1 or more and 3 or less carbons and a hydroxyalkyl group with 1 or more and 3 or less carbons, R^{3b} and R^{4b} are each independently a group selected from an alkyl group with 1 or more and 3 or less carbons and a hydroxyalkyl group with 1 or more and 3 or less carbons, and X-is an anion, and

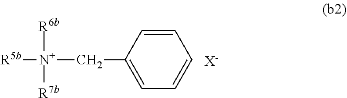

wherein R^{5b} is an aliphatic hydrocarbon group with 8 or more and 18 or less carbons, R^{6b} and R^{7b} are each independently a group selected from an alkyl group with 1 or more and 3 or less carbons and a hydroxyalkyl group with 1 or more and 3 or less carbons, and X-is an anion.

In the general formula (b1), R^{1b} has preferably 9 or more, more preferably 10 or more and further preferably 12 or more, and preferably 16 or less carbons from the viewpoint of foam durability during cleaning. R^{1b} is preferably an alkyl group or an alkenyl group and preferably an alkyl group.

In the general formula (b1), R^{2b} is a group selected from an aliphatic hydrocarbon group with 8 or more and 18 or less carbons, an alkyl group with 1 or more and 3 or less carbons and a hydroxyalkyl group with 1 or more and 3 or less carbons.

When R^{2b} is an aliphatic hydrocarbon group with 8 or more and 18 or less carbons, R^{2b} is preferably an alkyl group or an alkenyl group and preferably an alkyl group with preferably 8 or more, and preferably 14 or less and more preferably 12 or less carbons from the viewpoint of foam durability during cleaning.

In the general formula (b1), R^{3b} and R^{4b} are each independently a group selected from an alkyl group with 1 or more and 3 or less carbons and a hydroxyalkyl group with 1 or more and 3 or less carbons. R^{3b} and R^{4b} are preferably each independently a group selected from an alkyl group with 1 or more and 3 or less carbons. Examples of the alkyl group with 1 or more and 3 or less carbons include a methyl group, an ethyl group or a propyl group. Examples of the hydroxyalkyl group with 1 or more and 3 or less carbons include a hydroxymethyl group, a hydroxyethyl group or a hydroxypropyl group.

In the general formula (b1), X⁻ is an anion. Examples of the anion include halogen ions, for example, a chloride ion, a bromide ion and an iodide ion. Further, examples include alkyl sulfate ions with 1 or more and 3 or less carbons, for example, a methyl sulfate ion, an ethyl sulfate ion and a propyl sulfate ion.

Examples of a preferable compound of the compound of the general formula (b1) include one or more selected from an N-alkyl-N,N,N-trimethylammonium salt having an alkyl group with 12 or more and 18 or less carbons, an N,N-dialkyl-N,N-dimethyl-ammonium salt having an alkyl group with 8 or more and 16 or less carbons and an N-alkyl-N,N-dimethyl-N-ethylammonium salt having an alkyl group with 12 or more and 16 or less carbons.

In the general formula (b2), R^{5b} is an aliphatic hydrocarbon group with 8 or more and 18 or less carbons. R^{5b} has preferably 8 or more, more preferably 10 or more and further preferably 12 or more, and preferably 18 or less and more preferably 16 or less carbons from the viewpoint of foam durability during cleaning. R^{5b} is preferably an alkyl group or an alkenyl group and preferably an alkyl group.

In the general formula (b2), R^{6b} and R^{7b} are each independently a group selected from an alkyl group with 1 or more and 3 or less carbons and a hydroxyalkyl group with 1 or more and 3 or less carbons. R^{6b} and R^{7b} are preferably each independently a group selected from an alkyl group with 1 or more and 3 or less carbons. Examples of the alkyl group with 1 or more and 3 or less carbons include a methyl group, an ethyl group or a propyl group. Examples of the hydroxyalkyl group with 1 or more and 3 or less carbons include a hydroxymethyl group, a hydroxyethyl group or a hydroxypropyl group.

In the general formula (b2), X⁻ is an anion. Examples of the anion include halogen ions, for example, a chloride ion, a bromide ion and an iodide ion. Further, examples include alkyl sulfate ions with 1 or more and 3 or less carbons, for example, a methyl sulfate ion, an ethyl sulfate ion and a propyl sulfate ion.

Specific examples of the compound of the general formula (b2) include one or more compounds selected from an N-dodecyl-N,N-dimethyl-N-benzyl ammonium salt, an N-tridecyl-N,N-dimethyl-N-benzyl ammonium salt, an N-tetradecyl-N,N-dimethyl-N-benzyl ammonium salt, an N-pentadecyl-N,N-dimethyl-N-benzyl ammonium salt, an N-hexadecyl-N,N-dimethyl-N-benzyl ammonium salt, an N-dodecyl-N,N-diethyl-N-benzyl ammonium salt, an N-tridecyl-N,N-diethyl-N-benzyl ammonium salt, an N-tetradecyl-N,N-diethyl-N-benzyl ammonium salt, an N-pentadecyl-N,N-diethyl-N-benzyl ammonium salt, an N-hexadecyl-N,N-diethyl-N-benzyl ammonium salt, an N-dodecyl-N-methyl-N-ethyl-N-benzyl ammonium salt, an N-tridecyl-N-methyl-N-ethyl-N-benzyl ammonium salt, an N-tetradecyl-N-methyl-N-ethyl-N-benzyl ammonium salt, an N-pentadecyl-N-methyl-N-ethyl-N-benzyl ammonium salt and an N-hexadecyl-N-methyl-N-ethyl-N-benzyl ammonium salt.

### <Composition and Others>

The cleaning agent composition for hard articles of the present invention contains component (a) in an amount of preferably 0.5 mass % or more, more preferably 1 mass % or more, further preferably 3 mass % or more and furthermore preferably 5 mass % or more, and preferably 30 mass % or less, more preferably 25% mass or less, further preferably 20 mass % or less, furthermore preferably 15 mass % or less and furthermore preferably 10 mass % or less in the cleaning agent composition from the viewpoint of foam durability during cleaning.

In the cleaning agent composition for hard articles of the present invention, a content of component (a1) in component (a) is preferably 10 mass % or more, more preferably 15 mass % or more, further preferably 20 mass % or more and furthermore preferably 21 mass % or more, and preferably 100 mass % or less, more preferably 80 mass % or less, further preferably 70 mass % or less, furthermore preferably 60 mass % or less, furthermore preferably 50 mass % or less, furthermore preferably 40 mass % or less and furthermore preferably 30 mass % or less from the viewpoint of foam durability during cleaning.

The cleaning agent composition for hard articles of the present invention contains component (b) in an amount of preferably 0.01 mass % or more, more preferably 0.05 mass % or more, further preferably 0.1 mass % or more, furthermore preferably 0.5 mass % or more, furthermore preferably 1.0 mass % or more and furthermore preferably 1.2 mass % or more, and preferably 10.0 mass % or less, more preferably 5.0 mass % or less, further preferably 3.0 mass % or less, furthermore preferably 2.0 mass % or less and furthermore preferably 1.8 mass % or less in the cleaning agent composition from the viewpoint of foam durability during cleaning.

In the present invention, values expressed in terms of a chloride salt equivalent are used for specifications relating to the mass of component (b).

In the cleaning agent composition for hard articles of the present invention, a mass ratio of a content of component (a1) to a content of component (b), (a1)/(b), is preferably 0.1 or more, more preferably 0.5 or more and further preferably 1.0 or more, and preferably 100 or less, more preferably 50 or less, further preferably 30 or less, furthermore preferably 10 or less, furthermore preferably 2.0 or less and furthermore preferably 1.5 or less from the viewpoint of foam durability during cleaning.

The cleaning agent composition for hard articles of the present invention may optionally contain an anionic surfactant and an amphoteric surfactant as component (c), but their contents are limited. Note that the amphoteric surfactant excludes component (a2) in the present invention.

Examples of the anionic surfactant can include an alkyl sulfate or a salt thereof, a polyoxyalkylene alkyl ether sulfate or a salt thereof, an alkane sulfonic acid or a salt thereof, an alkylbenzene sulfonic acid or a salt thereof, a higher fatty acid or a salt thereof, a polyoxyethylene alkyl ether carboxylic acid or a salt thereof, an N-acyl amino acid or a salt thereof, an alkyl phosphate or a salt thereof, a polyoxyethylene alkyl ether phosphoric acid or a salt thereof or the like. Examples of the salts include sodium salts, potassium salts or other alkali metal salts, or the like.

Examples of the amphoteric surfactant can include an N-alkanoylaminopropyl-N,N-dimethyl-N-carboxymethyl ammonium betaine, an N-alkyl-N,N-dimethyl-N-carboxymethyl ammonium betaine, an N-alkyl-N,N-dimethyl-N-sulfopropyl ammonium sulfobetaine, an N-alkyl-N,N-dimethyl-N-(2-hydroxysulfopropyl) ammonium sulfobetaine, an N-alkanoylaminopropyl-N,N-dimethyl-N-sulfopropyl ammonium sulfobetaine, an N-alkanoylaminopropyl-N,N-dimethyl-N-(2-hydroxysulfopropyl) ammonium sulfobetaine or the like.

In the cleaning agent composition for hard articles of the present invention, a total surfactant content is preferably 1 mass % or more, more preferably 5 mass % or more and further preferably 8 mass % or more, and preferably 30 mass % or less, more preferably 20 mass % or less, further preferably 15 mass % or less and furthermore preferably 12 mass % or less from the viewpoint of foam durability during cleaning.

In the cleaning agent composition for hard articles of the present invention, a content of component (c) in the total surfactant content is preferably 0 mass % or more, and 20 mass % or less, preferably 10 mass % or less, more preferably 5 mass % or less, further preferably 3 mass % or less, furthermore preferably 1 mass % or less and furthermore preferably 0.5 mass % or less from the viewpoint of foam durability during cleaning.

In the present invention, when an anionic surfactant is contained as component (c), values expressed in terms of a sodium salt equivalent are used for specifications relating to its mass.

The cleaning agent composition for hard articles of the present invention may be free of component (c).

In the cleaning agent composition for hard articles of the present invention, a content of component (b) in the total surfactant content is preferably 1 mass % or more, more preferably 5 mass % or more, further preferably 8 mass % or more, furthermore preferably 10 mass % or more and furthermore preferably 12 mass % or more, and preferably 50 mass % or less, more preferably 30 mass % or less, further preferably 20 mass % or less and furthermore preferably 17 mass % or less from the viewpoint of foam durability during cleaning.

The cleaning agent composition for hard articles of the present invention can contain a water-miscible organic solvent as component (d) from the viewpoints of adjustability of viscosity of the composition and gel suppressibility.

A water-miscible organic solvent as used herein refers to a solvent which is soluble in an amount of 50 g or more in 1 L of ion exchange water at 25° C.

Examples of the water-miscible organic solvent include (d1) alkanols such as ethanol, 1-propanol, 2-propanol, 1-butanol and others, (d2) glycols such as propylene glycol, butylene glycol, hexylene glycol and others, (d3) glycols such as diethylene glycol, triethylene glycol, tetraethylene glycol, dipropylene glycol, tripropylene glycol and others, (d4) alkyl ethers such as diethylene glycol monomethyl ether, diethylene glycol dimethyl ether, triethylene glycol monomethyl ether, diethylene glycol monoethyl ether, diethylene glycol monobutyl ether, diethylene glycol diethyl ether, dipropylene glycol monomethyl ether, dipropylene glycol monoethyl ether, tripropylene glycol monomethyl ether, 1-methoxy-2-propanol, 1-ethoxy-2-propanol, 1-methyl glycerin ether, 2-methyl glycerin ether, 1,3-dimethyl glycerin ether, 1-ethyl glycerin ether, 1,3-diethyl glycerin ether, triethyl glycerin ether, 1-pentyl glyceryl ether, 2-pentyl glyceryl ether, 1-octyl glyceryl ether, 2-ethylhexyl glyceryl ether, diethylene glycol monobutyl ether and others, (d5) aromatic ethers such as 2-phenoxyethanol, diethylene glycol monophenyl ether, triethylene glycol monophenyl ether, a polyethylene glycol monophenyl ether with an average molecular weight of about 480, phenoxy propylene glycol, 2-benzyloxyethanol, diethylene glycol monobenzyl ether and others and (d6) ethylene oxide and/or propylene oxide polymers with an average molecular weight of 500 or more and 5000 or less, specifically, a polypropylene glycol with an average molecular weight of from 500 to 5000, a polyethylene glycol with a molecular weight of 500 or more and 5000 or less and an oxypropylene oxyethylene copolymer with a molecular weight of 500 or more and 5000 or less (which may be either block or random), and one or more of these can be used.

From the viewpoint of appearance transparency, component (d) is preferably one or more selected from diethylene glycol monobutyl ether, ethanol, propylene glycol, diethylene glycol, 2-phenoxyethanol and a polypropylene glycol with a molecular weight of 500 or more and 3000 or less, more preferably one or more selected from diethylene glycol monobutyl ether, ethanol, propylene glycol and a polypropylene glycol with a molecular weight of 500 or more and 3000 or less, and further preferably one or more selected from diethylene glycol monobutyl ether and a polypropylene glycol with a molecular weight of 500 or more and 3000 or less.

The cleaning agent composition for hard articles of the present invention contains component (d) in an amount of preferably 0.1 mass % or more, more preferably 0.5 mass % or more and further preferably 1 mass % or more, and preferably 20 mass % or less, more preferably 10 mass % or less, further preferably 5 mass % or less and furthermore preferably 2 mass % or less in the cleaning agent composition from the viewpoint of appearance transparency.

The cleaning agent composition for hard articles of the present invention can be formulated with components such as surfactants, solvents, enzymes (proteolytic enzymes, lipolytic enzymes, glycolytic enzymes and others), hydrotropic agents, pH adjusters, thickening agents, dispersants, viscosity adjusters, fragrances, colorants, antioxidants, antiseptics and others (excluding those which qualify as component (a) including components (a1), (a2), (a3) and (a4), component (b), component (c) and component (d)) in the range that the purposes of the present invention are not impaired.

The cleaning agent composition for hard articles of the present invention contains water. Examples of the water are not particularly limited, but include tap water, well water, ion exchange water, distilled water or the like. In the present invention, water is preferably used in an amount of the balance of the cleaning agent composition (an amount which makes the total 100 mass %). A content of water can be, for example, 50 mass % or more, further 60 mass % or more and further 70 mass % or more in the cleaning agent composition.

The cleaning agent composition for hard articles of the present invention has a pH of preferably 3 or more, more preferably 5 or more and further preferably 6 or more, and preferably 10 or less, more preferably 9 or less and further preferably 8 or less at 20° C. from the viewpoint of ease of handling.

Note that the pH is a value determined by a glass electrode method.

The cleaning agent composition for hard articles of the present invention can be intended for various hard articles, but is preferably used for tableware and/or kitchen hard articles and more preferably used for tableware.

The kitchen hard articles are articles used in and around kitchens, specifically,
(1) storage areas for food, tableware and cooking utensils, such as refrigerators, cupboards and others,
(2) food preparation areas such as drains, cooktops, range hoods, sinks, gas ranges, microwave ovens and others, and
(3) walls or floors around the storage areas or the preparation areas, and others. In the present invention, these are referred to as “kitchen hard articles” for convenience.

Further, specific examples of the tableware include components or utensils coming in contact with foodstuffs, such as
(i) so-called tableware such as plates, bowls and others,
(ii) storage containers such as Tupperware, jars and others,
(iii) cooking utensils such as knives, cutting boards, pots, pans, fish grills and others, and
(iv) cooking appliances such as food processors, mixers and others, or the like. In the present invention, these are referred to as “tableware” for convenience.

Further, the present invention is preferably intended for articles selected from the tableware, storage containers, cooking utensils and cooking appliances and even more preferably intended for articles selected from plates, bowls, Tupperware, jars, knives, cutting boards, pots, pans, fish grills, food processors and mixers.

Examples of materials for the hard articles covered by the present invention include plastic (including silicone resin and others), metal, ceramic, wood and a combination of those. Further, the cleaning agent composition for hard articles of the present invention can effectively clean oil stains, particularly oil stains including denatured oil stains, adhering to these hard articles.

### <Method for Cleaning Hard Article>

The present invention provides a method for cleaning a hard article including, foaming the cleaning agent composition for hard articles of the present invention and bringing the same into contact with the hard article adhered with a stain. The matters stated in the cleaning agent composition for hard articles of the present invention can be appropriately applied to the method for cleaning a hard article of the present invention.

In the method for cleaning a hard article of the present invention, the cleaning agent composition for hard articles of the present invention is foamed and brought into contact with the hard article. For example, the cleaning agent composition for hard articles of the present invention can be, for example, foamed with a sponge or foamed with a sprayer having a foam forming mechanism and brought into contact with the hard article.

Examples of the target hard article in the method for cleaning a hard article of the present invention include those which are stated in the cleaning agent composition for hard articles of the present invention. Tableware is one suitable hard article.

In the method for cleaning a hard article of the present invention, the stain adhering to the hard article may be an oil stain such as a denatured oil stain or the like, and further, may be a denatured oil stain.

A method for bringing the cleaning agent composition for hard articles of the present invention into contact with the hard article adhered with an oil stain or the like is preferably a method for applying the cleaning agent composition for hard articles of the present invention in foam form. Specifically, for example, a spray tool is used for bringing the composition of the present invention into contact with the hard article. In other words, in the present invention, it is preferable to use a cleaning agent article for hard articles obtained by filling the cleaning agent composition for hard articles of the present invention into a container having a sprayer.

Examples of the method for applying the composition in foam form can include, for example, a method in which air is entrained in the cleaning agent composition for hard articles of the present invention at a nozzle portion of a sprayer to make foam, or a method in which the cleaning agent composition for hard articles of the present invention is put on a sponge or a cleaning textile article or the like, and the sponge or cleaning textile article or the like is thereafter rubbed several times to make foam.

The present invention provides a cleaning agent article for hard articles contained in a spray container obtained by filling the cleaning agent composition for hard articles of the present invention into the container having a sprayer.

Examples of the container having a sprayer in the cleaning agent article for hard articles contained in a spray container of the present invention include a manual spray device using no propellant, such as a trigger-type spray container, a pump-type spray container or the like, an aerosol using a propellant, or the like. The container having a sprayer is preferably a trigger-type spray capable of spraying or applying the content in foam form, and more preferably a trigger-type spray having a mechanism for forming foam from the content (foam forming mechanism).

When a trigger-type spray having a foam forming mechanism is used, the cleaning agent article for hard articles contained in a spray container of the present invention sprays the cleaning agent composition in an amount of preferably 0.5 mL or more and more preferably 1 mL or more, and preferably 30 mL or less, more preferably 15 mL or less and further preferably 5 mL or less per operation.

In the method for cleaning a hard article of the present invention, the cleaning agent composition for hard articles of the present invention is foamed and brought into contact with the hard article to clean the hard article. In the cleaning method of the present invention, the hard article can be cleaned by removing the stain from the hard article, for example, in such a manner that foam made by foaming the composition is applied to the hard article and left as-is, the hard article is thereafter scrubbed with a sponge or a textile product, and the composition is washed away with running water, or the like. Further, rinsing can be thereafter carried out with running water or the like. The cleaning method of the present invention may be a hand-washing cleaning method, in which a hard article such as tableware or the like can be hand-washed in conformance with a publicly-known technique.

### [Method for Increasing Foamability of Cleaning Agent Composition for Hard Articles]

The present invention provides a method for increasing foamability of a cleaning agent composition for hard articles, the cleaning agent composition for hard articles containing the above component (a) and water, the method including containing the above component (b) in the composition.

If component (b) is contained in the cleaning agent composition for hard articles containing component (a) and water, foamability of the cleaning agent composition for hard articles can be increased, and cleaning durability when cleaning hard articles with foam made by foaming the composition can be enhanced.

The aspects stated in the cleaning agent composition for hard articles and the method for cleaning a hard article of the present invention can be appropriately applied to the method for increasing foamability of a cleaning agent composition for hard articles of the present invention.

In the method for increasing foamability of a cleaning agent composition for hard articles of the present invention, in addition to component (b), optionally the above component (C) and optionally the above component (d) can be contained in the cleaning agent composition for hard articles containing component (a) and water.

A cleaning agent composition for hard articles obtained by containing component (b), optionally component (c) and optionally component (d) in the cleaning agent composition for hard articles containing component (a) and water is the cleaning agent composition for hard articles of the present invention, and the specifications for the aspects of each component, the content of each component and the mass ratio of each component stated in the cleaning agent composition for hard articles of the present invention can be appropriately applied thereto.

### EXAMPLES

The cleaning agent compositions for hard articles in Tables 1 and 2 were prepared by using the formulation components below. The cleaning agent compositions for hard articles in Tables 1 and 2 were each obtained by adding components (a), (b), (c) and (d) in formulation amounts in the tables and dissolving them at a room temperature (20° C.). After formulation, citric acid was added to adjust a pH to the value shown in the tables. Note that the pH values were measured by a glass electrode method. Further, the mass percentages of the formulation components in Tables 1 and 2 are all numerical values based on effective amounts.

### <Formulation Component>

### Component (a)

AMIET 102: polyoxyethylene (2.1) lauryl amine, component (a1), a compound of the general formula (a1) in which R^{1a} is an alkyl group with 12 carbons and m+n is 2.1, manufactured by Kao Corporation
AMIET 105: polyoxyethylene (4) coco alkyl amine, component (a1), a compound of the general formula (a1) in which R^{1a} is an alkyl group with 8 to 18 carbons and m+n is 4, manufactured by Kao Corporation
AMIET 302: polyoxyethylene (2.1) alkyl (C14 to 18) amine, component (a1), a compound of the general formula (a1) in which R^{1a} is an alkyl group with 14 to 18 carbons and m+n is 2.1, manufactured by Kao Corporation
Amine EO adduct: polyoxyethylene (7) lauryl amine, component (a1), a compound of the general formula (a1) in which R^{1a} is an alkyl group with 12 carbons and m+n is 7.
AMIET 308: polyoxyethylene (9.1) coco alkyl amine, component (a1′) (comparative component of component (a1)), a compound of the general formula (a1) in which R^{1a} is an alkyl group with 14 to 18 carbons and m+n is 9.1, manufactured by Kao Corporation
AMIET 320: polyoxyethylene (20) coco alkyl amine, component (a1′) (comparative component of component (a1)), a compound of the general formula (a1) in which R^{1a} is an alkyl group with 14 to 18 carbons and m+n is 19.6, manufactured by Kao Corporation
AMPHITOL 20N: lauryldimethylamine oxide, component (a2), a compound of the general formula (a2) in which R^{2a} is an alkyl group with 12 carbons, R^{3a} and R^{4a} are methyl groups, and q is 0 and p is 0, manufactured by Kao Corporation
AMPHITOL 40N: myristyl dimethylamine oxide, component (a2), a compound of the general formula (a2) in which R^{2a} is an alkyl group with 14 carbons, R^{3a} and R^{4a} are methyl groups, and q is 0 and p is 0, manufactured by Kao Corporation
AMPHITOL 08N: capryl dimethylamine oxide, component (a2), a compound of the general formula (a2) in which R^{2a} is an alkyl group with 8 carbons, R^{3a} and R^{4a} are methyl groups, and q is 0 and p is 0, manufactured by Kao Corporation
AG-124: alkyl polyglycoside, component (a3), a compound of the general formula (a3) in which R^{5a} is an alkyl group with 10 to 14 carbons, G is a residue derived from glucose, x is 0, and y is 1.3, manufactured by Kao Corporation
GE-EH: 2-ethylhexyl glyceryl ether, component (a4), manufactured by Kao Corporation

### Component (b)

SANISOL B-50: benzyl-alkyl (C12 to 16) dimethyl ammonium chloride, a compound of the general formula (b2) in which R^{5b} is an alkyl group with 12 to 16 carbons (60 mass % of C12, 30 mass % of C14 and 10 mass % of C16), R^{6b} and R^{7b} are methyl groups, and X⁻ is a chloride ion, manufactured by Kao Corporation
LEVENOL RK: benzyl-alkyl (C8 to 18) dimethyl ammonium chloride, a compound of the general formula (b2) in which R^{5b} is an alkyl group with 8 to 18 carbons (80 mass % of C10), R^{6b} and R^{7b} are methyl groups, and X-is a chloride ion, manufactured by Kao Corporation
SANISOL 08: benzyl-octyl dimethyl ammonium chloride, a compound of the general formula (b2) in which R^{5b} is an alkyl group with 8 carbons, R^{6b} and R^{7b} are methyl groups, and X⁻ is a chloride ion, manufactured by Kao Corporation
QUARTAMIN 60W: cetyl trimethyl ammonium chloride, a compound of the general formula (b1) in which Rib is an alkyl group with 16 carbons, R^{2b}, R^{3b} and R^{4b} are methyl groups, and X⁻ is a chloride ion, manufactured by Kao Corporation

### Component (c)

NEOPELEX G-25: sodium alkyl benzene sulfonate (soft type) having an alkyl group with 10 to 14 carbons, manufactured by Kao Corporation Component (d)
BDG: diethylene glycol monobutyl ether, manufactured by SINO-JAPAN CHEMICAL CO., LTD.
PPG-1000: polypropylene glycol, molecular weight 1000, manufactured by AGC Inc.

### <Cleaning Durability During Foaming Cleaning>

1 g of an oil stain (tallow/rape seed oil=1/1, mass ratio) was applied to a ceramic plate (diameter 23 cm). After the oil stain was applied, the ceramic plate was left as-is at 25° C. for 2 hours to obtain a contaminated plate for evaluation. A plurality of contaminated plates for evaluation were prepared.

A sponge (manufactured by KIKULON CO., LTD.) was impregnated with 1 g of each prepared cleaning agent composition for hard articles in Tables 1 and 2 and 30 g of tap water (30° C.) and rubbed several times to foam the composition, and a contaminated plate for evaluation was thereafter cleaned with it. A state where the plate was not sticky when touched with a finger after cleaning was considered to be the completion of cleaning. After the completion of cleaning, without changing the sponge (and without newly impregnating it with the composition), the composition was foamed again and a new contaminated plate for evaluation was cleaned with it, thus repeating cleaning until cleaning could no longer be completed. Durability of the cleaning foam was evaluated by the number of contaminated plates for evaluation for which cleaning could be completed while foaming was maintained. The results are shown in Tables 1 and 2.

### <Appearance Evaluation>

40 mL of each prepared cleaning agent composition for hard articles in Tables 1 and 2 was filled into a 50-mL sample bottle (No. 6 wide-mouth standard bottle, made of glass, a cylindrical shape with a diameter of 40 mm and a height of 80 mm, letters for checking evaluations were printed on the circumferential surface of the bottle) and covered with a lid, and then, left to stand within a thermostatic chamber at 25° C. for 1 hour. The appearance of the composition after leaving it to stand was visually observed and determined in accordance with the criteria below. The results are shown in Tables 1 and 2.

Transparent: a state in which the composition is not turbid, and the letters are clearly visible over the sample bottle

Slightly turbid: a state in which the composition is slightly turbid, but the letters are visible over the sample bottle

Cloudy: a state in which the composition is turbid, and the letters are not visible at all over the sample bottle

TABLE 1

| | | | | | Example | | | | | | | | |
|---|---|---|---|---|---|---|---|---|---|---|---|---|---|
| | | | | | 1 | 2 | 3 | 4 | 5 | 6 | 7 | 8 | 9 |
| Cleaning | Formulation | (a) | (a1) | AMIET 102 | 2 | 2 | 2 | 2 | 2 | 2 | 2 | 2 | 2 |
| agent | composition | | | Amine EO | | | | | | | | | |
| composition | (mass %) | | | adduct | | | | | | | | | |
| for hard | | | (a2) | AMPHITOL | 1 | 1 | 1 | 1 | 1 | 1 | 1 | 1 | 1 |
| articles | | | | 20N | | | | | | | | | |
| | | | | AMPHITOL | 2 | 2 | 2 | 2 | 2 | 2 | 2 | 2 | 2 |
| | | | | 40N | | | | | | | | | |
| | | | | AMPHITOL | 0.4 | 0.4 | 0.4 | 0.4 | 0.4 | 0.4 | 0.4 | 0.4 | 0.4 |
| | | | | 08N | | | | | | | | | |
| | | | (a3) | AG-124 | 2.5 | 2.5 | 2.5 | 2.5 | 2.5 | 2.5 | 2.5 | 2.5 | 2.5 |
| | | | (a4) | GE-EH | 0.83 | 0.83 | 0.83 | 0.83 | 0.83 | 0.83 | 0.83 | 0.83 | 0.83 |

| | | | | | | | | | | |
|---|---|---|---|---|---|---|---|---|---|---|
| (b) | SANISOL B-50 | 0.05 | 0.1 | 0.6 | 1 | 1.5 | 2 | 3 | | |
| | LEVENOL RK | | | | | | | | 1.5 | |
| | SANISOL 08 | | | | | | | | | 1.5 |
| | QUARTAMIN | | | | | | | | | |
| | 60 W | | | | | | | | | |
| (c) | NEOPELEX G-25 | | | | | | | | | |
| (d) | BDG | 1 | 1 | 1 | 1 | 1 | 1 | 1 | 1 | 1 |
| | PPG-1000 | 0.1 | 0.1 | 0.1 | 0.1 | 0.1 | 0.1 | 0.1 | 0.1 | 0.1 |

| | | | | | | | | | |
|---|---|---|---|---|---|---|---|---|---|
| Water | Balance | Balance | Balance | Balance | Balance | Balance | Balance | Balance | Balance |
| Total | 100 | 100 | 100 | 100 | 100 | 100 | 100 | 100 | 100 |

| | | | | | | | | | |
|---|---|---|---|---|---|---|---|---|---|
| pH (20° C.) | 7.1 | 7.1 | 7.1 | 7.1 | 7.1 | 7.1 | 7.1 | 7.1 | 7.1 |
| Total surfactant content | 8.78 | 8.83 | 9.33 | 9.73 | 10.2 | 10.7 | 11.7 | 10.2 | 10.2 |
| (mass %) | | | | | | | | | |
| (a1)/(a) (mass %) | 22.9 | 22.9 | 22.9 | 22.9 | 22.9 | 22.9 | 22.9 | 22.9 | 22.9 |
| (a1)/(b) (mass ratio) | 40.0 | 20.0 | 3.3 | 2.0 | 1.3 | 1.0 | 0.7 | 1.3 | 1.3 |
| (b)/total surfactant content | 0.6 | 1.1 | 6.4 | 10.3 | 14.7 | 18.6 | 25.6 | 14.7 | 14.7 |
| (mass %) | | | | | | | | | |
| (c)/total surfactant content | 0 | 0 | 0 | 0 | 0 | 0 | 0 | 0 | 0 |
| (mass %) | | | | | | | | | |

| | | | | | | | | | |
|---|---|---|---|---|---|---|---|---|---|
| Cleaning durability during foaming | 4 | 4 | 4 | 5 | 7 | 6 | 5 | 5 | 5 |
| cleaning (number of cleaned | | | | | | | | | |
| plates) | | | | | | | | | |
| Appearance evaluation | Transparent | Transparent | Transparent | Transparent | Transparent | Transparent | Transparent | Transparent | Transparent |

| | | | | | Example | | | | | | Comparative example | |
|---|---|---|---|---|---|---|---|---|---|---|---|---|
| | | | | | 10 | 11 | 12 | 13 | 14 | 15 | 1 | 2 |
| Cleaning | Formulation | (a) | (a1) | AMIET 102 | 2 | 3 | 1 | 2 | 2 | | 2 | 2 |
| agent | composition | | | Amine EO | | | | | | 2 | | |
| composition | (mass %) | | | adduct | | | | | | | | |
| for hard | | | (a2) | AMPHITOL | 1 | 3 | 2 | 1 | 1 | 1 | 1 | 1 |
| articles | | | | 20N | | | | | | | | |
| | | | | AMPHITOL | 2 | 1.5 | 1 | 2 | 2 | 2 | 2 | 2 |
| | | | | 40N | | | | | | | | |
| | | | | AMPHITOL | 0.4 | | | 0.4 | 0.4 | 0.4 | 0.4 | 0.4 |
| | | | | 08N | | | | | | | | |
| | | | (a3) | AG-124 | 2.5 | | 2.5 | 2.5 | 2.5 | 2.5 | 2.5 | |
| | | | (a4) | GE-EH | 0.83 | | 0.83 | 0.83 | 0.83 | 0.83 | 0.83 | 0.83 |

| | | | | | | | | | |
|---|---|---|---|---|---|---|---|---|---|
| (b) | SANISOL B-50 | | 2 | 1.5 | 1.5 | 1.5 | 1 | | 1 |
| | LEVENOL RK | | | | | | | | |
| | SANISOL 08 | | | | | | | | |
| | QUARTAMIN | 1.5 | | | | | | | |
| | 60 W | | | | | | | | |
| (c) | NEOPELEX G-25 | | | | 0.1 | 1 | | | 2.5 |
| (d) | BDG | 1 | 1 | 1 | 1 | 1 | 1 | 1 | 1 |
| | PPG-1000 | 0.1 | 0.1 | 0.1 | 0.1 | 0.1 | 0.1 | 0.1 | 0.1 |

| | | | | | | | | |
|---|---|---|---|---|---|---|---|---|
| Water | Balance | Balance | Balance | Balance | Balance | Balance | Balance | Balance |
| Total | 100 | 100 | 100 | 100 | 100 | 100 | 100 | 100 |

| | | | | | | | | |
|---|---|---|---|---|---|---|---|---|
| pH (20° C.) | 7.1 | 7.1 | 7.1 | 7.1 | 7.1 | 7.1 | 7.1 | 7.1 |
| Total surfactant content | 10.2 | 9.5 | 8.83 | 10.3 | 11.2 | 9.73 | 8.73 | 9.73 |
| (mass %) | | | | | | | | |
| (a1)/(a) (mass %) | 22.9 | 40.0 | 13.6 | 22.9 | 22.9 | 22.9 | 22.9 | 32.1 |
| (a1)/(b) (mass ratio) | 1.3 | 1.5 | 0.7 | 1.3 | 1.3 | 2.0 | 1 | 2.0 |
| (b)/total surfactant content | 14.7 | 21.1 | 17.0 | 14.5 | 13.4 | 10.3 | 0.0 | 10.3 |
| (mass %) | | | | | | | | |
| (c)/total surfactant content | 0 | 0 | 0 | 1 | 9 | 0 | 0 | 26 |
| (mass %) | | | | | | | | |

| | | | | | | | | |
|---|---|---|---|---|---|---|---|---|
| Cleaning durability during foaming | 5 | 5 | 6 | 5 | 5 | 5 | 3 | 1 |
| cleaning (number of cleaned | | | | | | | | |
| plates) | | | | | | | | |
| Appearance evaluation | Transparent | Transparent | Transparent | Transparent | Slightly | Slightly | Transparent | Turbid |

| | |
|---|---|
| turbid | turbid |

TABLE 2

| | | | | | Example | | | | | | Comparative example | | |
|---|---|---|---|---|---|---|---|---|---|---|---|---|---|
| | | | | | 16 | 17 | 18 | 19 | 20 | 21 | 3 | 4 | 5 |
| Cleaning | Formulation | (a) | (a1) | AMIET 102 | 8 | 5 | 2 | 1 | | | 8 | | |
| agent | composition | | | AMIET 105 | | | | | 2 | | | | |
| composition | (mass %) | | | AMIET 302 | | | | | | 2 | | | |
| for | | | (a1′) | AMIET 308 | | | | | | | | 8 | |
| hard | | | | AMIET 320 | | | | | | | | | 8 |
| articles | | | (a2) | AMPHITOL 20N | 2 | 5 | 8 | 9 | 8 | 8 | 3.5 | 2 | 2 |

| | | | | | | | | | |
|---|---|---|---|---|---|---|---|---|---|
| (b) | SANISOL B-50 | 1.5 | 1.5 | 1.5 | 1.5 | 1.5 | 1.5 | 1.5 | 1.5 |

| | | | | | | | | | |
|---|---|---|---|---|---|---|---|---|---|
| Water | Balance | Balance | Balance | Balance | Balance | Balance | Balance | Balance | Balance |
| Total | 100 | 100 | 100 | 100 | 100 | 100 | 100 | 100 | 100 |

| | | | | | | | | | |
|---|---|---|---|---|---|---|---|---|---|
| pH (20° C.) | 7.1 | 7.1 | 7.1 | 7.1 | 7.1 | 7.1 | 7.1 | 7.1 | 7.1 |
| Total surfactant content (mass %) | 11.5 | 11.5 | 11.5 | 11.5 | 11.5 | 11.5 | 11.5 | 11.5 | 11.5 |
| (a1)/(a) (mass %) | 80.0 | 50.0 | 20.0 | 10.0 | 20.0 | 20.0 | 69.6 | 0 | 0 |
| (a1)/(b) (mass ratio) | 5.3 | 3.3 | 1.3 | 0.7 | 1.3 | 1.3 | - | | - |
| (b)/total surfactant content | 13 | 13 | 13 | 13 | 13 | 13 | 0 | 13 | 13 |
| (mass %) | | | | | | | | | |

| | | | | | | | | | |
|---|---|---|---|---|---|---|---|---|---|
| Cleaning durability during foaming | 5 | 5 | 5 | 5 | 6 | 5 | 3 | 2 | 2 |
| cleaning (number of cleaned plates) | | | | | | | | | |
| Appearance evaluation | Transparent | Transparent | Transparent | Transparent | Transparent | Transparent | Transparent | Transparent | Transparent |

1. A cleaning agent composition for hard articles comprising, (a) a nonionic surfactant [hereinafter referred to as component (a)] containing a polyoxyalkylene alkyl or alkenyl amine [hereinafter referred to as component (a1)] in which the alkyl group or alkenyl group has 8 or more and 18 or less carbons and the oxyalkylene group has an average number of added moles of 1 or more and 8 or less, (b) a quaternary ammonium salt-type surfactant [hereinafter referred to as component (b)] and water, wherein a content of (c) an anionic surfactant and an amphoteric surfactant [hereinafter referred to as component (c)] is 0 mass % or more and 20 mass % or less in a total surfactant content.

2. The cleaning agent composition for hard articles according to claim 1, wherein the component (a) comprises one or more selected from (a2) an amine oxide-type surfactant, (a3) an alkyl glycoside-type surfactant and (a4) an alkyl glyceryl ether-type surfactant.

3. The cleaning agent composition for hard articles according to claim 1, wherein a content of the component (a1) in the component (a) is 10 mass % or more and 100 mass % or less.

4. The cleaning agent composition for hard articles according to claim 1, wherein a content of the component (b) in the total surfactant content is 1 mass % or more and 50 mass % or less.

5. The cleaning agent composition for hard articles according to claim 1, wherein a content of the component (b) in the total surfactant content is 5 mass % or more and 30 mass % or less.

6. The cleaning agent composition for hard articles according to claim 1, wherein a mass ratio of a content of the component (a1) to a content of the component (b), (a1)/(b), is 0.1 or more and 100 or less.

7. The cleaning agent composition for hard articles according to claim 1, further comprising a water-miscible organic solvent in an amount of 0 mass % or more and 7 mass % or less as a component (d).

8. The cleaning agent composition for hard articles according to claim 1, wherein the total surfactant content is 1 mass % or more and 30 mass % or less.

9. A method for cleaning a hard article comprising, foaming the cleaning agent composition for hard articles according to claim 1 and bringing the same into contact with the hard article adhered with a stain.

10. The method for cleaning a hard article according to claim 9, wherein the cleaning agent composition for hard articles is foamed with a sponge or foamed with a sprayer having a foam forming mechanism and brought into contact with the hard article.

11. A method for increasing foamability of a cleaning agent composition for hard articles, the cleaning agent composition for hard articles containing (a) a nonionic surfactant containing a polyoxyalkylene alkyl or alkenyl amine in which the alkyl group or alkenyl group has 8 or more and 18 or less carbons and the oxyalkylene group has an average number of added moles of 1 or more and 5 or less and water, the method comprising containing (b) a quaternary ammonium salt-type surfactant in the composition.
